(19) United States
(12) Patent Application Publication
(10) Pub. No.: US 2024/0187633 A1
(43) Pub. Date: Jun. 6, 2024

(54) METHOD, DEVICE, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Zhipin DENG, Beijing (CN); Li ZHANG, Los Angeles, CA (US); Kai ZHANG, Los Angeles, CA (US); Na ZHANG, Beijing (CN)

(21) Appl. No.: 18/287,605

(22) PCT Filed: Apr. 21, 2022
(86) PCT No.: PCT/CN2022/088142

§ 371 Date: Oct. 19, 2023

(30) Foreign Application Priority Data
Apr. 21, 2021 (WO) PCT/CN2021/088798

(51) Int. Cl. H04N 19/513; H04N 19/176; H04N 19/186; H04N 19/70

(52) U.S. Cl. CPC H04N 19/513; H04N 19/176; H04N 19/186; H04N 19/70

(57) ABSTRACT

Embodiments of the present disclosure provide a solution for video processing. A method for video processing is proposed. The method comprises: obtaining, during a conversion between a target video unit in a target picture of a video and a bitstream of the video, second coding data of the target video unit based on first coding data of the target video unit and at least one refinement process, the at least one refinement process being applied based on a predefined criterion; and performing the conversion based on the second coding data. Compared with the conventional solution, the proposed method can advantageously improve the coding performance and efficiency.

### FIELD

Embodiments of the present disclosure relates generally to video coding techniques, and more particularly, to refinement in image or video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally very low, which is undesirable.

### SUMMARY

Embodiments of the present disclosure provide a solution for video processing.

In a first aspect, a method for video processing is proposed. The method comprises: obtaining, during a conversion between a target video unit in a target picture of a video and a bitstream of the video, second coding data of the target video unit based on first coding data of the target video unit and at least one refinement process, the at least one refinement process being applied based on a predefined criterion; and performing the conversion based on the second coding data. The method in accordance with the first aspect of the present disclosure refines motion data of coding blocks before or after motion compensation. Additionally, the refinement process can be conducted flexibly based on the type of the coding technique and requirements on video processing. Compared with the conventional solution, the proposed method can advantageously improve the coding efficiency and enable a more precise prediction.

In a second aspect, an apparatus for video processing is proposed. The apparatus comprises a processor and a non-transitory memory coupled to the processor and having instructions stored thereon, wherein the instructions upon execution by the processor, cause the processor to: obtain, during a conversion between a target video unit in a target picture of a video and a bitstream of the video, second coding data of the target video unit based on first coding data of the target video unit and at least one refinement process, the at least one refinement process being applied based on a predefined criterion; and generate the bitstream based on the second coding data.

In a third aspect, a non-transitory computer-readable storage medium is proposed. The non-transitory computer-readable storage medium storing instructions that cause a processor to perform a method in accordance with the first aspect of the present disclosure.

In a fourth aspect, a non-transitory computer-readable recording medium is proposed. The non-transitory computer-readable recording medium storing a bitstream of a video which is generated by a method performed by an apparatus for video processing, wherein the method comprises: obtaining, during a conversion between a target video unit in a target picture of a video and a bitstream of the video, second coding data of the target video unit based on first coding data of the target video unit and at least one refinement process, the at least one refinement process being applied based on a predefined criterion; and generating the bitstream based on the second coding data.

In a fifth aspect, a method for storing a bitstream of a video is proposed. The method comprises: obtaining, during a conversion between a target video unit in a target picture of a video and a bitstream of the video, second coding data of the target video unit based on first coding data of the target video unit and at least one refinement process, the at least one refinement process being applied based on a predefined criterion; generating the bitstream based on the second coding data; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram of an example video coding system in accordance with some embodiments of the present disclosure;

FIG. 2 illustrates a block diagram of an example video encoder in accordance with some embodiments of the present disclosure;

FIG. 3 illustrates a block diagram of an example video decoder in accordance with some embodiments of the present disclosure;

FIG. 4 is a schematic diagram illustrating positions of a spatial merge candidate;

FIG. 5 is a schematic diagram illustrating candidate pairs considered for redundancy check of spatial merge candidates;

FIG. 6 illustrates motion vector scaling for temporal merge candidate;

FIG. 7 is a schematic diagram illustrating candidate positions for temporal merge candidate, C0 and C1;

FIG. 8 is a schematic diagram illustrating a merge mode with motion vector differences (MMVD) search point;

FIG. 9 is a schematic diagram illustrating the decoding side motion vector refinement;

FIG. 10 illustrates examples of the geometric partitioning mode (GPM) splits grouped by identical angles;

FIG. 11 is a schematic diagram illustrating the uni-prediction MV selection for geometric partitioning mode;

FIG. 12 is a schematic diagram illustrating the exemplified generation of a bending weight w₀ using GPM;

FIG. 13 is a schematic diagram illustrating the top and left neighboring blocks used in combined inter and intra prediction (CIIP) weight derivation;

FIG. 14 is a schematic diagram illustrating the template matching that performs on a search area around initial MV;

FIG. 15 is a schematic diagram illustrating diamond regions in the search area;

FIG. 16 is a schematic diagram illustrating spatial neighboring blocks used to derive the spatial merge candidates;

FIG. 17 illustrates a flowchart of a method for video processing in accordance with some embodiments of the present disclosure; and

FIG. 18 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

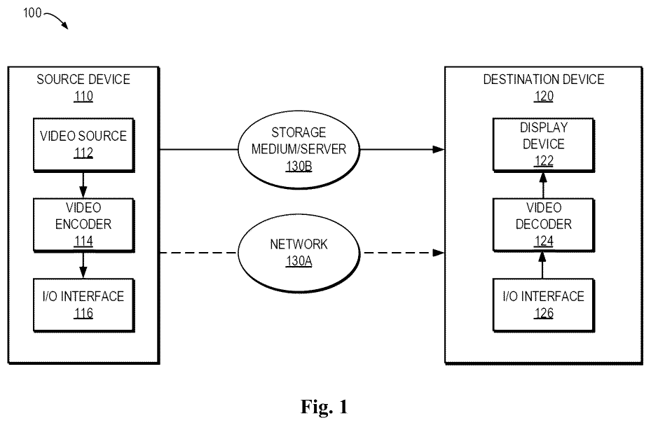

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to the destination device 120 via the I/O interface 116 through a network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or future standards.

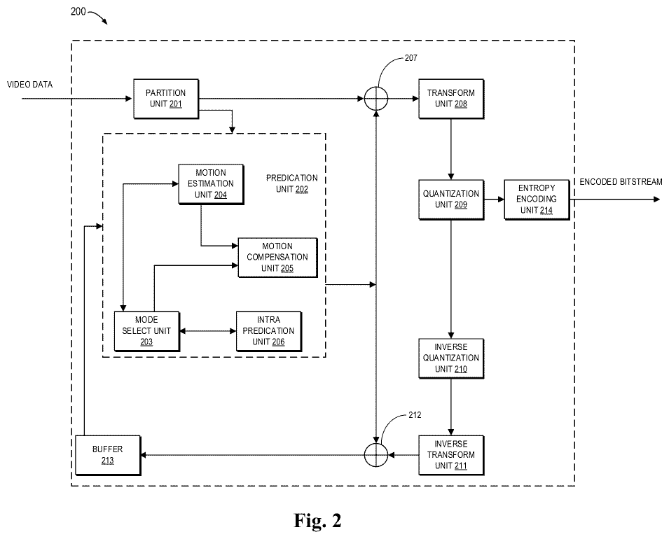

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode selection unit 203, a motion estimation unit 204, a motion compensation unit 205 and an intra prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and a video decoder 300 (which will be discussed in detail below) may support various video block sizes.

The mode selection unit 203 may select one of the coding modes, intra or inter, e.g., based on error results, and provide the resulting intra-coded or inter-coded block to the residual generation unit 207 to generate residual block data and to the reconstruction unit 212 to reconstruct the encoded block for use as a reference picture. In some examples, the mode selection unit 203 may select a combination of intra and inter predication (CIIP) mode in which the predication is based on an inter predication signal and an intra predication signal. The mode selection unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, the video encoder 200 may predictively signal the motion vector. Two examples of predictive signaling techniques that may be implemented by the video encoder 200 include advanced motion vector predication (AMVP) and merge mode signaling.

The intra prediction unit 206 may perform intra prediction on the current video block. When performing intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform unit 208 may generate one or more transform coefficient video blocks for the current video block by applying one or more transforms to a residual video block associated with the current video block.

After the transform unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, a loop filtering operation may be performed to reduce video blocking artifacts in the video block.

The entropy encoding unit 214 may receive data from other functional components of the video encoder 200. When the data is received, the entropy encoding unit 214 may perform one or more entropy encoding operations to generate entropy encoded data and output a bitstream that includes the entropy encoded data.

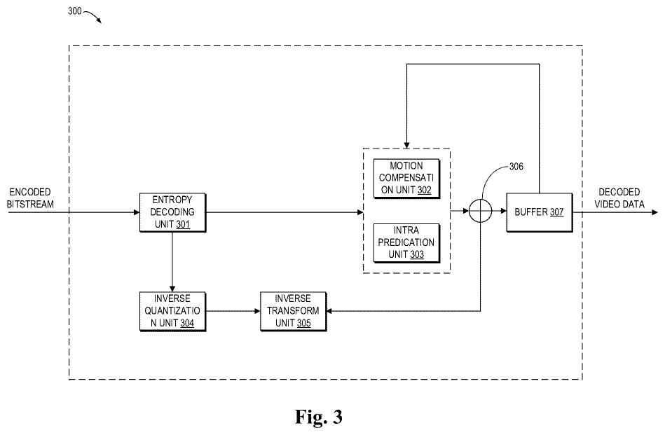

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transform unit 305, a reconstruction unit 306, and a buffer 307. The video decoder 300 may, in some examples, perform a decoding pass that is generally reciprocal to the encoding pass as described with respect to the video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes, which, for example, are received in the bitstream, to form a prediction block from spatially adjacent blocks. The inverse quantization unit 304 inverse quantizes, i.e., de-quantizes, the quantized video block coefficients provided in the bitstream and decoded by the entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some example embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Summary

This disclosure is related to video coding technologies. Specifically, it is about prediction mode refinement, motion information refinement, prediction samples refinement related techniques in video coding. It may be applied to the existing video coding standard like HEVC, VVC, and etc. It may be also applicable to future video coding standards or video codec.

### 2. Background

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards (ITU-T and ISO/IEC, “High efficiency video coding”, Rec. ITU-T H.265|ISO/IEC 23008-2 (in force edition)). Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1. Explanation of Coding Tools

### 2.1.1. Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.1.1.1. Spatial Candidates Derivation

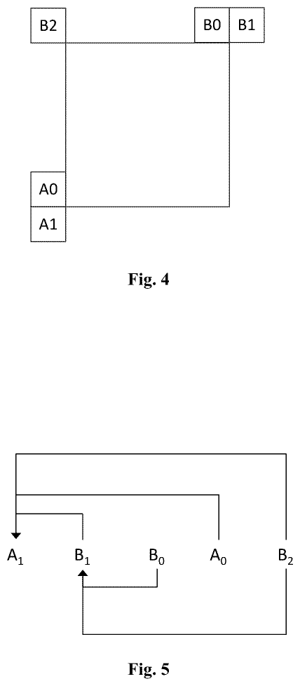

The derivation of spatial merge candidates in VVC is same to that in HEVC except the positions of first two merge candidates are swapped. A maximum of four merge candidates are selected among candidates located in the positions depicted in FIG. 4. The order of derivation is B₀, A₀, B₁, A₁ and B₂. Position B₂ is considered only when one or more than one CUs of position B₀, A₀, B₁, A₁ are not available (e.g. because it belongs to another slice or tile) or is intra coded. After candidate at position A, is added. the addition of the remaining candidates is subject to a redundancy check which ensures that candidates with same motion information are excluded from the list so that coding efficiency is improved. To reduce computational complexity, not all possible candidate pairs are considered in the mentioned redundancy check. Instead only the pairs linked with an arrow in FIG. 5 are considered and a candidate is only added to the list if the corresponding candidate used for redundancy check has not the same motion information.

### 2.1.1.2. Temporal Candidates Derivation

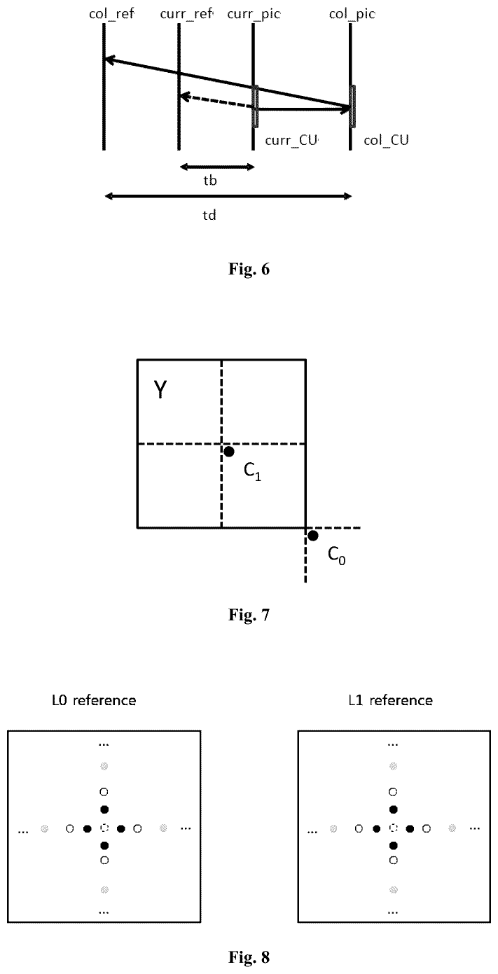

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. The scaled motion vector for temporal merge candidate is obtained as illustrated by the dotted line in FIG. 6, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 7. If CU at position C₀ is not available, is intra coded, or is outside of the current row of CTUs, position C₁ is used. Otherwise, position C₀ is used in the derivation of the temporal merge candidate.

### 2.1.1.3. History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward,

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1. Number of HMPV candidates is used for merge list generation is set as (N<=4)?M: (8−N), wherein N indicates number of existing candidates in the merge list and M indicates number of available HMVP candidates in the table.
2. Once the total number of available merge candidates reaches the maximally allowed merge candidates minus 1, the merge candidate list construction process from HMVP is terminated.

### 2.1.1.4. Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid.

When the merge list is not full after pair-wise average merge candidates are added, the zero MVPs are inserted in the end until the maximum merge candidate number is encountered.

### 2.1.1.5. Merge Estimation Region

Merge estimation region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log2ParMrgLevel is greater than xCb>>Log2ParMrgLevel and (yCb+cbHeight)>>Log2ParMrgLevel is great than (yCb>>Log2ParMrgLevel) and where (xCb, yCb) is the top-left luma sample position of the current CU in the picture and (cbWidth, cbHeight) is the CU size. The MER size is selected at encoder side and signalled as log2_parallel_merge_level_minus2 in the sequence parameter set.

2.1.2. Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a skip flag and merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The merge candidate flag is signalled to specify which one is used.

Distance index specifies motion magnitude information and indicate the pre-defined offset from the starting point. As shown in FIG. 8, an offset is added to either horizontal component or vertical component of starting MV. The relation of distance index and pre-defined offset is specified in Table 1

TABLE 1
The relation of distance index and pre-defined offset

| Distance IDX | 0 | 1 | 2 | 3 | 4 | 5 | 6 | 7 |
|---|---|---|---|---|---|---|---|---|
| Offset (in unit | ¼ | ½ | 1 | 2 | 4 | 8 | 16 | 32 |
| of luma sample) | | | | | | | | |

Direction index represents the direction of the MVD relative to the starting point. The direction index can represent of the four directions as shown in Table 2. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 2 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), the sign in Table 2 specifies the sign of MV offset added to the list0 MV component of starting MV and the sign for the list1 MV has opposite value.

TABLE 2
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 2.1.3. Decoder Side Motion Vector Refinement (DMVR)

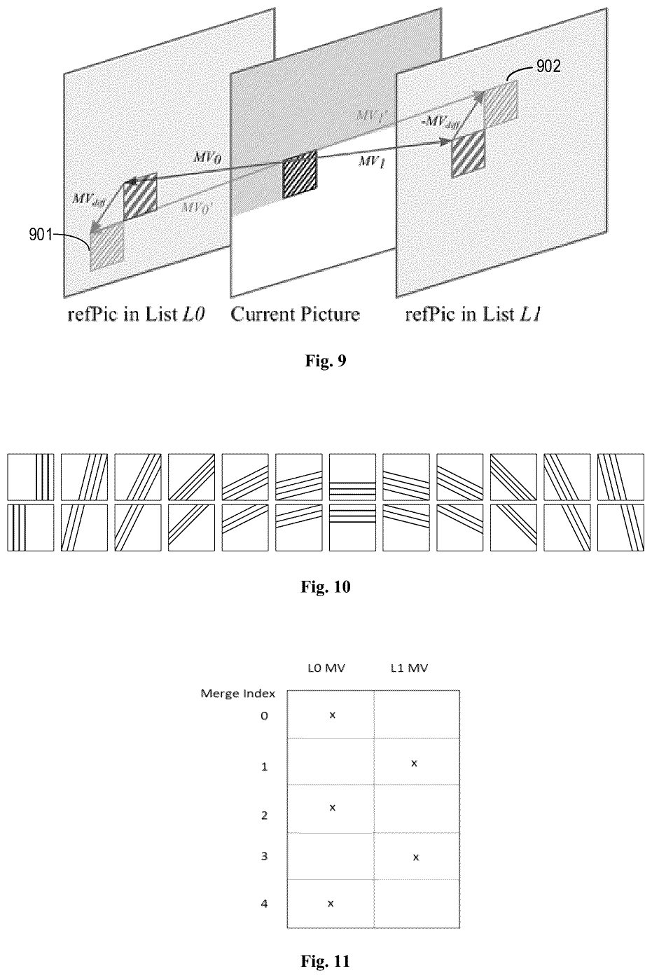

In order to increase the accuracy of the MVs of the merge mode, a bilateral-matching based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. As illustrated in FIG. 9, the SAD between the blocks 901 and 902 based on each MV candidate around the initial MV is calculated. The MV candidate with the lowest SAD becomes the refined MV and used to generate the bi-predicted signal.

In VVC, the DMVR can be applied for the CUs which are coded with following modes and features:
CU level merge mode with bi-prediction MV
One reference picture is in the past and another reference picture is in the future with respect to the current picture
The distances (i.e. POC difference) from two reference pictures to the current picture are same
Both reference pictures are short-term reference pictures
CU has more than 64 luma samples
Both CU height and CU width are larger than or equal to 8 luma samples
BCW weight index indicates equal weight
WP is not enabled for the current block
CIIP mode is not used for the current block

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

### 2.1.3.1. Searching Scheme

In DVMR, the search points are surrounding the initial MV and the MV offset obey the MV difference mirroring rule. In other words, any points that are checked by DMVR, denoted by candidate MV pair (MV0, MV1) obey the following two equations:

MV0,=MV0+MV_offset (1)

MV1,=MV1−MV_offset (2)

Where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form

E(x,y)=A(x−xₘᵢₙ)²+B(y−yₘᵢₙ)²+C (3)

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

xₘᵢₙ=(E(−1,0)−E(1,0))/(2(E(−1,0)+E(1,0)−2E(0,0))) (4)

yₘᵢₙ=(E(0,−1)−E(0,1))/(2((E(0,−1)+E(0,1)−2E(0,0))) (5)

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

### 2.1.3.2. Bilinear-Interpolation and Sample Padding

In VVC, the resolution of the MVs is 1/16 luma samples. The samples at the fractional position are interpolated using a 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

### 2.1.3.3. Maximum DMVR Processing Unit

When the width and/or height of a CU are larger than 16 luma samples, it will be further split into subblocks with width and/or height equal to 16 luma samples. The maximum unit size for DMVR searching process is limit to 16×16.

### 2.1.4. Geometric Partitioning Mode (GPM) for Inter Prediction

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m,n∈{3 . . . 6} excluding 8×64 and 64×8.

When this mode is used, a CU is split into two parts by a geometrically located straight line (FIG. 10). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived using the process described in 3.4.1.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights as in 3.4.2. This is the prediction signal for the whole CU, and transform and quantization process will be applied to the whole CU as in other prediction modes. Finally, the motion field of a CU predicted using the geometric partition modes is stored as in 2.1.4.3.

### 2.1.4.1. Uni-Prediction Candidate List Construction

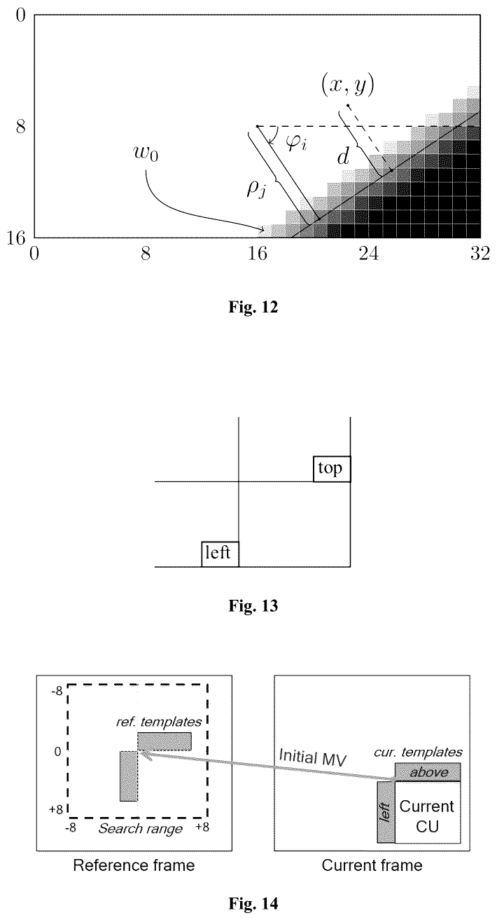

The uni-prediction candidate list is derived directly from the merge candidate list constructed according to the extended merge prediction process in 2.1.1. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. These motion vectors are marked with “x” in FIG. 11. In case a corresponding LX motion vector of the n-the extended merge candidate does not exist, the L(1−X) motion vector of the same candidate is used instead as the uni-prediction motion vector for geometric partitioning mode.

### 2.1.4.2. Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 6 )$$

$${ρ}_{j} = {ρ}_{x , j} cos ( {φ}_{i} ) + {ρ}_{y , j} sin ( {φ}_{i} ) \qquad ( 7 )$$

$$\begin{matrix}{p}_{x , j} = \{ \begin{matrix}0 & i \% 16 = 8 or ( i \% 16 \neq 0 and h \geq w ) \\ \pm ( j \times w ) ≫ 2 & otherwise\end{matrix} & ( 8 )\end{matrix}$$

$${p}_{y , j} = \{ \begin{matrix}\pm ( j \times h ) ≫ 2 & i \% 16 = 8 or ( i \% 16 \neq 0 and h \geq w ) \\ 0 & otherwise\end{matrix} \qquad ( 9 )$$

where i,j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 10 )$$

$${w}_{0} ( x , y ) = \frac{Clip 3 ( 0 , 8 , ( wIdxL ( x , y ) + 4 ) ≫ 3 )}{8} \qquad ( 11 )$$

$${w}_{1} ( x , y ) = 1 - {w}_{0} ( x , y ) \qquad ( 12 )$$

The partIdx depends on the angle index i. One example of weigh wo is illustrated in FIG. 12.

### 2.1.4.3. Motion Field Storage for Geometric Partitioning Mode

Mv1 from the first part of the geometric partition, Mv2 from the second part of the geometric partition and a combined Mv of Mv1 and Mv2 are stored in the motion filed of a geometric partitioning mode coded CU.

The stored motion vector type for each individual position in the motion filed are determined as:

sType=abs_{(motionIdx)}<32?2:_{(motionIdx≤0?(1-partIdx): partIdx)} (13)

where motionIdx is equal to d(4x+2, 4y+2). The partIdx depends on the angle index i.

If sType is equal to 0 or 1, Mv0 or Mv1 are stored in the corresponding motion field, otherwise if sType is equal to 2, a combined Mv from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.
   2.2. Geometric Prediction Mode with Motion Vector Differences (GMVD)

With Geometric prediction mode with Motion Vector Difference (GMVD), each geometric partition in GPM can decide to use GMVD or not. If GMVD is chosen for a geometric region, the MV of the region is calculated as a sum of the MV of a merge candidate and an MVD. All other processing is kept the same as in GPM.

With GMVD, an MVD is signaled as a pair of direction and distance, following the current design of MMVD. That is, there are eight candidate distances (¼-pel, ½-pel, 1-pel, 2-pel, 4-pel, 8-pel, 16-pel, 32-pel), and four candidate directions (toward-left, toward-right, toward-above, and toward-below). In addition, when pic_fpel_mmvd_enabled_flag is equal to 1, the MVD in GMVD is also left shifted by 2 as in MMVD.

### 2.3. Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pinter is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks (depicted in FIG. 13) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

P_{CIIP}=((4−wt)*Pᵢₙₜₑᵣ+wt*Pᵢₙₜᵣₐ+2)>>2 (3-1)

### 2.4. Multi-Hypothesis Prediction (MHP)

The multi-hypothesis prediction is adopted in this contribution. Up to two additional predictors are signalled on top of inter AMVP mode, regular merge mode, and MMVD mode. The resulting overall prediction signal is accumulated iteratively with each additional prediction signal.

Pₙ₊₁=(1−αₙ₊₁)pₙ+αₙ₊₁hₙ₊₁

The weighting factor α is specified according to the following table:

| add_hyp_weight_idx | α |
|---|---|
| 0 | ¼ |
| 1 | −⅛ |

For inter AMVP mode, MHP is only applied if non-equal weight in BCW is selected in bi-prediction mode.

### 2.5. Template Matching (TM)

Template matching (TM) is a decoder-side MV derivation method to refine the motion information of the current CU by finding the closest match between a template (i.e., top and/or left neighbouring blocks of the current CU) in the current picture and a block (i.e., same size to the template) in a reference picture. As illustrated in FIG. 14, a better MV is to be searched around the initial motion of the current CU within a [−8, +8]-pel search range. The template matching is adopted in this contribution with two modifications: search step size is determined based on AMVR mode and TM can be cascaded with bilateral matching process in merge modes.

In AMVP mode, an MVP candidate is determined based on template matching error to pick up the one which reaches the minimum difference between current block template and reference block template, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 3. This search process ensures that the MVP candidate still keeps the same MV precision as indicated by AMVR mode after TM process.

TABLE 3
Search patterns of AMVR and merge mode with AMVR.

| | AMVR mode | | | | Merge mode | |
|---|---|---|---|---|---|---|
| | | Full- | Half- | Quarter- | AltIF = | AltIF = |
| Search pattern | 4-pel | pel | pel | pel | 0 | 1 |
| 4-pel diamond | v | | | | | |
| 4-pel cross | v | | | | | |
| Full-pel | | v | v | v | v | v |
| diamond | | | | | | |
| Full-pel cross | | v | v | v | v | v |
| Half-pel cross | | | v | v | v | v |
| Quarter-pel | | | | v | v | |
| cross | | | | | | |
| ⅛-pel cross | | | | | v | |

In merge mode, similar search method is applied to the merge candidate indicated by the merge index. As Table 3 shows, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

### 2.6. Multi-Pass Decoder-Side Motion Vector Refinement

In this contribution, a multi-pass decoder-side motion vector refinement is applied. In the first pass, bilateral matching (BM) is applied to the coding block. In the second pass, BM is applied to each 16×16 subblock within the coding block. In the third pass. MV in each 8×8 subblock is refined by applying bi-directional optical flow (BDOF). The refined MVs are stored for both spatial and temporal motion vector prediction.

### First Pass—Block Based Bilateral Matching MV Refinement

In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW*cbH is greater than 64, MRSAD cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range. 11

The existing fractional sample refinement is further applied to derive the final deltaMV. The refined MVs after the first pass is then derived as:
MV0_pass1=MV0+deltaMV
MV1_pass1=MV1−deltaMV

### Second Pass—Subblock Based Bilateral Matching MV Refinement

In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2(sbIdx2) and MV1_pass2(sbIdx2)) are derived based on the minimum bilateral matching cost between the two reference subblocks in L0 and L1.

For each subblock, BM performs full search to derive integer sample precision intDeltaMV. The full search has a search range [−sHor, sHor] in horizontal direction and [−sVer, sVer] in vertical direction, wherein, the values of sHor and sVer are determined by the block dimension, and the maximum value of sHor and sVer is 8.

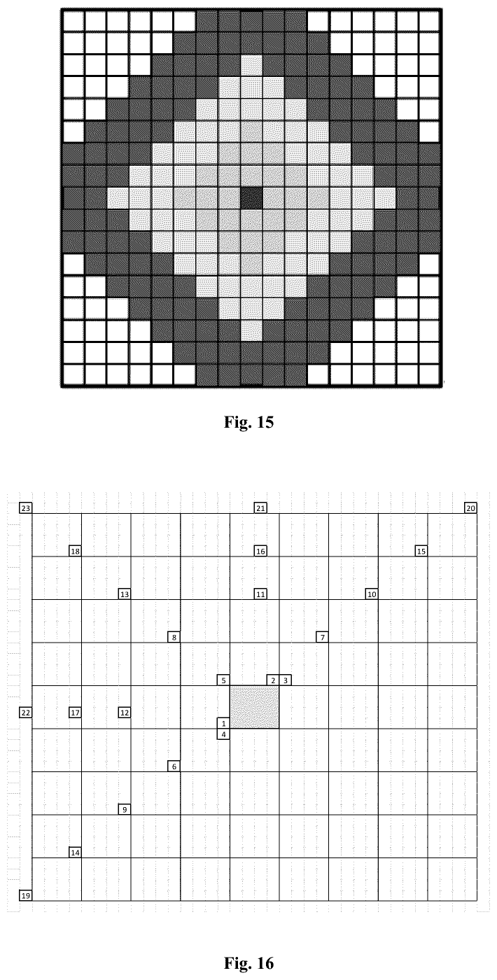

The bilateral matching cost is calculated by applying a cost factor to the SATD cost between two reference subblocks, as: bilCost=satdCost*costFactor. The search area (2*sHor+1)*(2*sVer+1) is divided up to 5 diamond shape search regions shown on FIG. 15. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined.

The existing VVC DMVR fractional sample refinement is further applied to derive the final deltaMV(sbIdx2). The refined MVs at second pass is then derived as:
MV0_pass2(sbIdx2)=MV0_pass1+deltaMV(sbIdx2)
MV1_pass2(sbIdx2)=MV1_pass1−deltaMV(sbIdx2)

### Third Pass—Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.

The refined MVs (MV0_pass3(sbIdx3) and MV1_pass3(sbIdx3)) at third pass are derived as:
MV0_pass3(sbIdx3)=MV0_pass2(sbIdx2)+bioMv
MV1_pass3(sbIdx3)=MV0_pass2(sbIdx2)−bioMv

### 2.7. Non-Adjacent Spatial Candidate

The non-adjacent spatial merge candidates are inserted after the TMVP in the regular merge candidate list. The pattern of spatial merge candidates is shown in FIG. 16. The distances between non-adjacent spatial candidates and current coding block are based on the width and height of current coding block. The line buffer restriction, however, is not applied in this contribution.

### 2.8. GPM Motion Refinement

The detailed embodiments below should be considered as examples to explain general concepts. These embodiments should not be interpreted in a narrow way. Furthermore, these embodiments can be combined in any manner.

The term ‘GPM’ may represent a coding method that split one block into two or more sub-regions wherein at least one sub-region is non-rectangular, or non-square, or it couldn't be generated by any of existing partitioning structure (e.g., QT/BT/TT) which splits one block into multiple rectangular sub-regions. In one example, for the GPM coded blocks, one or more weighting masks are derived for a coding block based on how the sub-regions are split, and the final prediction signal of the coding block is generated by a weighted-sum of two or more auxiliary prediction signals associated with the sub-regions.

The term ‘GPM’ may indicate the geometric merge mode (GEO), and/or geometric partition mode (GPM), and/or wedge prediction mode, and/or triangular prediction mode (TPM), and/or a GPM block with motion vector difference (GMVD), and/or a GPM block with motion refinement, and/or any variant based on GPM.

The term ‘block’ may represent a coding block (CB), a CU, a PU, a TU, a PB, a TB.

The phrase “normal/regular merge candidate” may represent the merge candidates generated by the extended merge prediction process (as illustrated in section 3.1). It may also represent any other advanced merge candidates except GEO merge candidates and subblock based merge candidates.

Note that a part/partition of a GPM/GMVD block means a part of a geometric partition in the CU, e.g., the two parts of a GPM block in FIG. 10 are split by a geometrically located straight line. Each part of a geometric partition in the CU is inter-predicted using its own motion, but the transform is performed for the whole CU rather than each part/partition of a GPM block.

It should also be noticed that GPM/GMVD applied to other modes (e.g., AMVP mode) may also use the following methods wherein the motion for merge mode may be replaced by motion for AMVP mode.

It is noticed that in the following descriptions, the term ‘GPM merge list’ is given as an example. However, the proposed solutions could also be extended to other GPM candidate list, such as GPM AMVP candidate list.

In the disclosure, a merge candidate is called to be “refined” if the motion information of the merge candidate is modified according to information signaled from the encoder or derived at the decoder. For example, a merge candidate may be refined by DVMR, FRUC, TM, MMVD, BDOF and so on.
1. In one example, during the GPM merge list construction process, the GPM motion information may be generated from a refined regular merge candidate.
   1) For example, the refinement process may be conducted on a regular merge candidate list, before the GPM merge list construction process. E.g., the GPM merge list may be constructed based on refined regular merge candidates.
   2) For example, refined L0 motion and/or L1 motion of a regular merge candidate may be used as a GPM merge candidate.
      a) For example, a bi-prediction regular merge candidate may be firstly refined by a decoder side motion derivation/refinement process, and then being used for derivation of GPM motion information.
      b) For example, a uni-prediction regular merge candidate may be firstly refined by a decoder side motion derivation/refinement process, and then being used for derivation of GPM motion information.
   3) Whether to refine a merge candidate or a merge candidate list may depend on the motion information of the candidates.
      a) For example, if a normal merge candidate satisfies the condition of the decoder side motion derivation/refinement method, then this normal merge candidate may be firstly refined by such method, and then being used for derivation of GPM motion information.
2. In one example, after deriving the GPM motion information according to candidate indices (e.g., using the parity and candidate indices to a regular merge candidate list in VVC), the motion information may be further refined by another process.
   1) Alternatively, furthermore, the final prediction of a GPM coded video unit may be dependent on the refined motion information.
   2) For example, the refinement process may be conducted on a GPM merge candidate list, after the GPM merge list construction process. E.g., the GPM merge list may be constructed based on non-refined regular merge candidates.
   3) For example, a GPM merge candidate list (e.g., uni-prediction) is firstly build from a regular merge candidate list, and then any of the GPM merge candidates may be further refined through decoder side motion derivation methods.
3. In one example, a two-stage refinement process may be applied.
   1) For example, a first refinement process may be conducted on a regular merge candidate list, before the GPM merge list construction process. E.g., the GPM merge list may be constructed based on regular merge candidates refined by the first refinement process.
   2) For example, a second refinement process may be conducted on a GPM merge candidate list, after the GPM merge list construction process.
4. In one example, the motion refinement of a GPM block may be conducted for multiple candidates (e.g., corresponding to multiple parts, e.g., both part-0 motion and part-1 motion), simultaneously.
   1) Alternatively, the motion refinement of a GPM block may be conducted for part-0 motion and part-1 motion, respectively.
5. In one example, the motion refinement of a GPM block may be applied to at least one part of a GPM block.
   1) For example, the motion refinement of a GPM block may be applied to both parts of a GPM block.
   2) For example, the motion refinement of a GPM block may be applied to a certain part (not both) of a GPM block, wherein the part index may be predefined or determined by a rule.
6. In one example, the aforementioned motion refinement (e.g., decoder side motion derivation) process may be based on a bilateral matching method (such as DMVR which measures the prediction sample difference between L0 prediction block and L1 prediction block).
   1) For example, the L0/L1 prediction in the bilateral matching of a GPM block may take into account the whole block's information regardless of the GPM split mode information, e.g., a reference block with the same size of the whole GPM block is used a L0/L1 prediction.
      a) Alternatively, the L0/L1 prediction in the bilateral matching of a GPM block may take into account the GPM split mode information, e.g., a reference block with the block shape as same as the part-0/1 associated with a specific GPM split mode may be taken into account.
   2) Alternatively, the aforementioned motion refinement (e.g., decoder side motion derivation) process may be based on a template matching method (e.g., measures the prediction sample difference between template samples in the current picture and template samples in the reference picture, wherein template samples may be the above/left neighbors of the current video unit).
      a) Furthermore, the template may be uni-directional and/or bi-directional.
      b) For example, the template for part-0 and part-1 may be based on different rules.
      c) For example, the template matching process may be applied to a whole block, but the refinement information derived from the template matching process is applied to one part of the block.
      d) For example, the template matching may be applied to a part individually (not applying template matching on the whole block for two parts).
         a. In one example, the shape of a template for a part may depend on the shape of the part.
   3) Furthermore, whether to use bilateral matching method or template matching method to refine a regular merge candidate may be dependent on the motion data of the regular/GPM merge candidate (such as prediction direction, how different the L0 and L1 motion vectors are, POC distances of L0 and L1 motion, and etc.).
   4) Additionally, the refinement process may be applied for GPM motion, without explicit signalling.
      a) Alternatively, whether to allow the refinement or not may be explicitly signalled.
7. In one example, the refined motion may be used for the motion compensation for a GPM block.
   1) Alternatively, the original motion without the refinement may be used for the motion compensation for a GPM block.
8. In one example, the refined motion may be used for the subblock (e.g., 4×4) based motion vector storage for a GPM block.
   1) Alternatively, the original motion without the refinement may be used for the subblock based motion vector storage for a GPM block.
   2) In one example, the refined motion may be used for the deblocking strength determination for a GPM block.
      a) Alternatively, the original motion without the refinement may be used for the deblocking strength determination for a GPM block.
   3) In one example, when generating the AMVP/Merge candidate list for a succeeding block, which may be GPM-coded or non-GPM-coded, the refined motion of a GPM block may be used as 1) a temporal motion vector candidate when the temporal neighbor block is the GPM block, and/or 2) a spatial motion vector candidate when the spatial neighbor block is the GPM block.
      a) Alternatively, the original motion without the refinement may be used in any of the above-mentioned case.
9. In one example, MVD may be added to a refined MV for a block with GMVD mode.
   1) Alternatively, MVD may be added to a non-refined MV for a block with GMVD mode, and then the resulted MV is to be refined.
10. How to conduct the refinement process may be dependent on whether GPM and/or GMVD is used.
   1) For example, less searching points are checked in the refinement process if GPM and/or GMVD is used.

### 2.9. GPM Prediction Sample Refinement

The detailed embodiments below should be considered as examples to explain general concepts. These embodiments should not be interpreted in a narrow way. Furthermore, these embodiments can be combined in any manner.

The term ‘GPM’ may represent a coding method that split one block into two or more sub-regions wherein at least one sub-region is non-rectangular, or non-square, or it couldn't be generated by any of existing partitioning structure (e.g., QT/BT/TT) which splits one block into multiple rectangular sub-regions. In one example, for the GPM coded blocks, one or more weighting masks are derived for a coding block based on how the sub-regions are split, and the final prediction signal of the coding block is generated by a weighted-sum of two or more auxiliary prediction signals associated with the sub-regions.

The term ‘GPM’ may indicate the geometric merge mode (GEO), and/or geometric partition mode (GPM), and/or wedge prediction mode, and/or triangular prediction mode (TPM), and/or a GPM block with motion vector difference (GMVD), and/or a GPM block with motion refinement, and/or any variant based on GPM.

The term ‘block’ may represent a coding block (CB), a CU, a PU, a TU, a PB, a TB.

The phrase “normal/regular merge candidate” may represent the merge candidates generated by the extended merge prediction process (as illustrated in section 3.1). It may also represent any other advanced merge candidates except GEO merge candidates and subblock based merge candidates.

Note that a part/partition of a GPM/GMVD block means a part of a geometric partition in the CU, e.g., the two parts of a GPM block in FIG. 10 are split by a geometrically located straight line. Each part of a geometric partition in the CU is inter-predicted using its own motion, but the transform is performed for the whole CU rather than each part/partition of a GPM block.

It should also be noticed that GPM/GMVD applied to other modes (e.g., AMVP mode) may also use the following methods wherein the motion for merge mode may be replaced by motion for AMVP mode.
1. In one example, motion-compensated prediction sample refinement process may be applied to a GPM block.
   a. For example, at least one prediction sample of a GPM prediction block may be refined by an overlapped block-based motion compensation (e.g., OBMC) technique, in which the prediction samples are refined using neighboring block's motion information with a weighted prediction.
   b. For example, at least one prediction sample of a GPM prediction block may be refined by a multi-hypothesis prediction (e.g., MHP) technique in which the resulting overall prediction samples are weighted from accumulating more than one prediction signals from multiple hypothetical motion data.
   c. For example, at least one prediction sample of a GPM prediction block may be refined by a local illumination compensation (e.g., LIC) technique in which a linear model is used to compensate illumination change for the motion compensated luma samples.
   d. For example, at least one prediction sample of a GPM prediction block may be refined by a Combined Inter-Intra Prediction (CIIP) technique in which intra-prediction is used to refine the motion compensated luma samples.
   c. For example, at least one prediction sample of a GPM prediction block may be refined by a bi-directional optical-flow based motion refinement (e.g., BDOF or BIO) technique in which a pixel-wise motion refinement performed on top of block-wise motion compensation in a case of bi-prediction.
      1) For example, only if the two motion vectors of the two parts of a GPM block are from two different directions, the bi-directional optical-flow based motion refinement may be performed.
2. In one example, OBMC may be performed for all subblocks of a block coded with GPM.
   a. Alternatively, OBMC may be performed for some subblocks or some samples of a block coded with GPM.
      1) For example, OBMC may only be performed for subblocks at block boundaries of a block when the block is coded with GPM.
      2) For example, OBMC may only be performed for samples at block boundaries of a block when the block is coded with GPM.
3. In one example, when performing OBMC to a GPM block, the OBMC is applied based on the stored subblock (e.g., 4×4) based motion data of the current and neighboring GPM coded blocks.
   a. For example, the OBMC blending weights are determined based on the motion similarities between the stored subblock based motion of the current GPM subblock and the motion of the neighbor subblocks.
   b. Alternatively, in such case, the OBMC may be applied based the motion data derived from the GPM merge candidates (e.g., without considering the subblock based GPM motion derived from the motion index of each subblock), rather than the stored subblock based motion of a GPM block.
4. In one example, whether to apply a feature/tool on top of GPM block may be dependent on the temporal layer identifier (e.g., layer ID) of the current picture among the group of pictures (GOP) structure.
   a. For example, the aforementioned feature/tool may be based on any of the following techniques:
      1) MMVD
      2) OBMC
      3) MHP
      4) LIC
      5) CIIP
      6) Non-adjacent spatial merge candidate
      7) Decoder side motion refinement/derivation (e.g., template matching, bilateral matching, etc.)
   b. For example, a feature/tool may be applied to a GPM block when the current picture locates at pre-defined layer IDs, without extra signalling.
   c. For example, pictures of what layer IDs would have a feature/tool on a GPM block, may be explicit signalled.
5. In one example, in case motion vector difference is allowed to be used to a GPM block (named as GMVD), suppose M merge candidates are allowed for GPM without motion vector difference (named as GPM), and N merge candidates are allowed for GMVD, the following approaches are disclosed:
   a. In one example, the maximum allowed merge candidates' number of GMVD may be different from that of GPM without motion vector difference.
      1) For example, M may be greater than N.
         a) Alternatively, the maximum allowed merge candidates' numbers of GMVD and GPM are the same (e.g., M=N).
         b) Alternatively, M may be less than N.
      2) For example, the maximum allowed merge candidates' numbers of a GMVD coded block may be signalled in the bitstream, e.g., by a syntax element.
         a) Alternatively, the maximum allowed merge candidates' numbers of a GMVD coded block may be a predefined fixed value, such as N=2.
      3) The signalling of GPM merge candidates index (e.g., merge_gpm_idx0, merge_gpm_idx1) may be dependent on whether GMVD is used for the current video unit.
         a) For example, whether the current video block uses GMVD or not may be signalled before the GPM merge candidate index signalling.
         b) For example, when the current video block uses GMVD (e.g., either part of a GPM block uses GMVD), then the input parameters (e.g.,cMax) for GPM merge candidate index binarization may be based on the maximum allowed merge candidates number of GMVD (e.g., N).
         c) For example, when the current video block doesn't use GMVD (e.g., both parts of a GPM block don't use GMVD), then the input parameters (e.g.,cMax) for GPM merge candidate index binarization may be based on the maximum allowed merge candidates number of GPM without motion vector difference (e.g., N).
      4) In one example, a first syntax element (SE) to indicate whether GMVD is applied may depend on at least one GPM merge candidate index.
         a) For example, the first SE may not be signaled if the largest GPM merge candidate index signaled for the current block is larger than a threshold.
         b) For example, the first SE may not be signaled if the smallest GPM merge candidate index signaled for the current block is smaller than a threshold.
         c) If the first SE is not signaled, it may be inferred that GMVD is applied.
         d) If the first SE is not signaled, it may be inferred that GMVD is not applied.
   b. In one example, GMVD may select base candidate(s) from the K (such as K<=M) GPM merge candidates, and then add a motion vector difference on that base candidate.
      1) For example, the K GPM merge candidates may be the first K candidates in the list.
      2) For example, K=2.
      3) For example, the base candidate index of a GPM block/part may be signalled, and its binarization input parameter cMax may be determined based on the value of K.
      4) For example, multiple parts (e.g. all parts) of a GPM block may share a same base candidate.
      5) For example, each part of a GPM block uses its own base candidate.
   c. In one example, not all the MVD parameters for a GPM block (e.g., the MVD distances and MVD directions) of two parts of a GMVD block are signalled.
      1) In one example, the MVD parameters of a first part of a GPM block may be signalled.
         a) For example, the MVD parameters of the second part of a GPM block may be derived, e.g., based on the signalled MVD of the first part.
         b) For example, the method that only signal MVD for one of the two parts of a GPM block may be based on a rule.
         a) For example, the rule may be dependent on whether the motions of the two parts are pointing to different directions.
         b) For example, the rule may be dependent on whether two parts of a GPM block are coded with GMVD.
      2) For example, if the base candidate of GMVD is a bi-prediction candidate, the MVD parameters may be signalled for a first prediction direction.
         a) For example, the MVD derived from the signalled MVD parameters (such as MVD direction and MVD offset) may be applied to the LX motion, wherein X=0 or 1, while the L(1−X) motion is derived, e.g., based on the signalled MVD of the first prediction direction LX.
      3) For example, the derivation of MVD in the second part/direction may be based on a scaled or a mirrored style.
         a) For example, the derived MVD direction is based on mirroring the signalled MVD direction.
         a) For example, suppose the first signalled GMVD direction index (for the first part or prediction direction of a GMVD block) can be interpreted by gmvdSign[0][0] and gmvdSign[0][1] in horizontal direction and vertical direction, respectively. Therefore, the second derived GMVD direction (for the second part or prediction direction of a GMVD block) in horizontal may be equal to an opposite direction (such as gmvdSign[1][0]=−gmvdSign[0][0]) and/or the second derived GMVD direction in vertical may be equal to an opposite vertical direction (such as gmvdSign[1][1]=−gmvdSign[0][1]).
         b) For example, at least one GMVD direction (e.g., horizontal or vertical) of the second derived GMVD direction is opposite to those interpreted from the first signalled GMVD direction index.
         b) For example, the scaling factor of L(1−X) MVD offset is derived based on the POC distances of current-picture-to-L0-reference and current-picture-to-L1-reference.
         a) For example, suppose the first signalled GMVD distance (for the first part or prediction direction of a GMVD block) is denoted by gmvdDistance[0], and the POC distance between the first motion's reference picture and the current GMVD block is denoted by PocDiff[0], and, the POC distance between the second motion's reference picture and the current GMVD block is denoted by PocDiff [1]. Then the derived GMVD distance, gmvdDistance[1], may be derived based on PocDiff[0], PocDiff[1], and gmvdDistance[0].
         i. For example, gmvdDistance[1]=(gmvdDistance[0]>>a)<<b, wherein the value a is dependent on PocDiff [0], and the value b is dependent on PocDiff [1].
         ii. For example, gmvdDistance[1]=(gmvdDistance[0]<<b)/a, wherein the value a is dependent on PocDiff [0], and the value b is dependent on PocDiff [1].
      4) Alternatively, both LX and L(1−X) MVD offset are directly derived from the signalled MVD offset (e.g., without scaling or mirroring).
         a) For example, the second derived GMVD distance is equal to the first signalled GMVD distance, e.g., gmvdDistance[1]=gmvdDistance[0].
   d. In one example, more than one set of GMVD tables (e.g., GMVD directions, and/or GMVD offsets) may be defined for GPM mode.
      1) For example, which set of GMVD tables is allowed/used for a video unit may be explicitly signalled.
      2) For example, which set of GMVD tables is allowed/used for a video unit may be hard coded based on a pre-defined rule (such as picture resolutions).
   e. In one example, the final motion vector (e.g., GPM merge candidate plus the MVD offset) of at least one of the two GMVD parts must be different from the final MV of any one of the GPM merge candidate (which may be added by an MVD) in the GPM merge list.
      1) Alternatively, furthermore, the final motion vector of both GMVD parts are not allowed to be same with any of the GPM merge candidate in the GPM merge list.
      2) For example, if the final MV is the same to that of another GPM merge candidate, the final MV may be modified.
      3) For example, if the final MV is the same to that of another GPM merge candidate, the specific GPM merge candidate or MVD may be not allowed to be signaled.
   f. In one example, the final motion vectors of the two GMVD parts must be different from each other.
      1) Alternatively, the final motion vectors of the two GMVD parts may be the same but different from any one of the GPM merge candidate in the GPM merge list.
      2) For example, if the final MV of a part is the same to that of the other part, the final MV may be modified.
      3) For example, if the final MV of a first part is the same to that of the other part, the specific GPM merge candidate or MVD of the first part may be not allowed to be signaled.

### 3. Problems

There are several flaws in the VVC v1 standard, which would be further improved for higher coding gain.
1) In the VVC v1 standard, the motion data of some type of coded blocks (such as CIIP, GPM, Affine, MMVD, and SbTMVP etc.) is generated from a merge/AMVP candidate, without motion refinement. Considering the motion refinement before or after the motion compensation (e.g., MMVD, decoder side motion derivation/refinement such as DMVR, FRUC, template matching TM merge, TM AMVP and etc.), it would be more efficient if a motion vector of such kind of coding block is refined.
2) The prediction mode of some type of coded blocks (such as intra mode in the CIIP, regular intra mode etc.) may be refined using the decoded information, in order to generate more precise prediction.
3) The prediction samples of some type of coded blocks (such as AMVP, GPM, CIIP, SbTMVP, Affine, MMVD, DMVR, FRUC, TM merge, TM AMVP and etc.) may be refined using the decoded information (e.g., BDOF, OBMC, and etc.), in order to generate more precise prediction.
4) For new coding techniques (e.g., multi-hypothesis prediction, MHP, and etc.) introduced beyond VVC, the coding data (such as motion, mode, prediction samples) of the new coding tool coded video units may be further refined using the signalled/decoded information.

### 4. Embodiments of the Present Disclosure

The detailed embodiments below should be considered as examples to explain general concepts. These embodiments should not be interpreted in a narrow way. Furthermore, these embodiments can be combined in any manner.

The terms ‘video unit’ or ‘coding unit’ or ‘block’ may represent a coding tree block (CTB), a coding tree unit (CTU), a coding block (CB), a CU, a PU, a TU, a PB, a TB.

A block may be rectangular or non-rectangular.

In the disclosure, the phrase “regular motion candidate” may represent a merge motion candidate in a regular/extended merge list indicated by a merge candidate index, or an AMVP motion vector, or an AMVP motion candidate in regular/extended AMVP list indicated by an AMVP candidate index.

In the disclosure, a motion candidate is called to be “refined” if the motion information of the candidate is modified according to information signaled from the encoder or derived at the decoder. For example, a motion vector may be refined by DMVR, FRUC, TM merge, TM AMVP, MMVD, GMVD, affine MMVD BDOF and so on.

In the disclosure, the phrase “coding data refinement” may represent a refinement process in order to refine the signalled/decoded/derived prediction modes, prediction directions, or signalled/decoded/derived motion information, prediction and/or reconstruction samples for a video unit.
1. In one example, the coding data Z of a video unit coded by a particular coding technique X may be further refined by another process Y.
   1) For example, the coding data Z may be a signalled/decoded/derived prediction mode and/or prediction directions of the video unit.
   2) For example, the coding data Z may be signalled/decoded/derived motion information of the video unit.
      a) In one example, the coding data Z may be the motion information of a given reference picture list X (X being 0 or 1).
   3) For example, the coding data Z may be prediction samples or reconstruction samples of a video unit.
   4) For example, the particular coding technique X may be an AMVP candidate-based technique.
   5) For example, the particular coding technique X may be a merge candidate-based technique.
   6) For example, the particular coding technique X may be CIIP, MMVD, GPM, MHP, and etc.
   7) For example, the particular coding technique X may be a whole-block-based technique wherein all samples in the video unit share the same coding information.
      a) In one example, X may be regular merge, regular AMVP, CIIP, MHP, and etc.
   8) For example, the particular coding technique X may be a subblock-based technique wherein two sub-blocks in the video unit may use different coding information.
      a) In one example, X may be Affine, SbTMVP, and etc.
      b) In one example, X may be ISP, and etc.
      c) In one example, X may be GPM, GEO, TPM, and etc.
   9) For example, the particular coding technique X may be an inter prediction-based technique.
   10) For example, the particular coding technique X may be an intra prediction-based technique such as regular intra mode, MIP, CIIP, ISP, LM, IBC, BDPCM, and etc.
   11) For example, the particular refinement process Y may be based on explicitly signalling based method such as signalling motion vector differences, or intra mode delta values, or prediction and/or reconstruction block/sample delta values in a bitstream.
      a) In one example, for a particular coding technique X1 coded video unit, delta information may be explicitly signalled in a bitstream.
         i. Alternatively, for another particular coding technique X2 coded video unit, delta information may be derived by using decoded/reconstructed information which is available at the decoder side.
         ii. For example, the delta information may be one or more motion vector difference.
         a) For example, one or more motion vector differences may be added to a X-coded video unit.
         b) For example, more than one look up tables may be defined in a codec, to derive the actual motion vector difference for different MMVD based coding techniques.
         c) For example, a unified look up table may be defined in a codec, for all different MMVD based coding techniques.
         iii. For example, the delta information may be a delta value which can be used to generate a new prediction mode by adding up this delta value to a signalled/derived prediction mode.
         a) For example, the intra mode information of a video unit coded by CIIP (or, ISP, or regular Intra angular mode, or regular intra mode, and etc) may be refined by adding the delta value to a signalled/derived prediction mode.
         iv. For example, the delta information may be one or more delta values which can be used to generate one or more new prediction and/or reconstruction sample values.
      b) For example, the particular refinement process Y may be based on a filtering method.
         i. In one example, at least one filtering parameter is signaled to the decoder.
         ii. In one example, at least one filtering parameter is derived at the decoder.
   12) For example, the particular refinement process Y may be based on implicitly derivation related techniques.
      a) In one example, the Y may be based on the motion information of neighbouring video units (adjacent, or non-adjacent).
         i. In one example, the Y may be the OBMC process.
      b) For example, the particular refinement process Y may be based on a bilateral matching method such as DMVR which measures the prediction sample difference between L0 prediction block and L1 prediction block.
      c) In one example, the Y may be based on the reconstruction samples of neighbouring video units (adjacent, or non-adjacent).
         i. For example, the particular refinement process Y may be based on templated matching related techniques such as FRUC, TM merge, TM AMVP, TM IBC, BDOF, and etc.
         a) For example, the template may be constructed based on neighboring reconstructed samples on the top and/or left neighboring of the video unit, and, prediction/reconstructed samples at predefined locations in the reference area (e.g., within the current picture, or in a reference picture).
         b) For example, the reference samples of the template in the reference area may be derived based on a subblock based motion (e.g., each reference sub-template may be retrieved with individual motion information).
         c) For example, the reference samples of the template in the reference area may be derived based on single motion information.
         d) For example, whether the template matching is done in a way of uni-prediction or bi-prediction, may be dependent on the signalled motion information.
         i. For example, if the decoded/signalled motion information indicates that the current video unit is uni-predicted, the template matching based refinement may be conducted in a uni-prediction way (e.g., optimizing the motion vector according to a criteria based on the differences between a uni-predicted reference template and the template in the current picture).
         ii. For example, if the decoded/signalled motion information indicates that the current unit is bi-predicted, the template matching based refinement may be conducted in a bi-prediction way (e.g., optimizing the motion vector according to a criteria based on the differences between more than one reference templates/the combination of more than one reference templates and the template in the current picture).
         iii. For example, the template matching based refinement may be always conducted in a bi-prediction way, regardless the prediction direction obtained from the decoded/signalled motion information.
         1. Furthermore, alternatively, whether to take this solution may be dependent on the type of the coding technique X that applied the video unit.
         iv. For example, the template matching based refinement may be always conducted in a uni-prediction way, regardless the prediction direction obtained from the decoded/signalled motion information.
         1. Furthermore, alternatively, whether to take this solution may be dependent on the type of the coding technique X that applied the video unit.
2. For one video unit, multiple refinement processes may be applied.
   1) In one example, at least two refinement processes may be applied wherein each of the two is used to refine one kind of coding data.
      a) In one example, the motion information and intra prediction modes may be both refined.
         i. Alternatively, furthermore, the above methods may be applied to CIIP-coded blocks.
         ii. Alternatively, furthermore, the above methods may be applied to video unit with inter and intra combined prediction mode.
   2) In one example, at least two refinement processes may be applied wherein both of them are used to refine the same kind of coding data.
      a) In one example, the motion information may be refined using multiple ways, e.g., DMVR and TM based methods.
      b) Alternatively, furthermore, the final refined motion information to be applied may be further determined from the temporary refined motion information from the multiple ways.
         a) In one example, the temporary refined motion information from one among the multiple ways may be utilized as the final refined motion information to be applied.
         c) Alternatively, furthermore, the final reconstruction/prediction block generation process may be dependent on the temporary refined motion information from the multiple ways.
3. In one example, the refinement process may be applied to one or more parts within a video unit.
   1) For example, the refinement process may be applied to a video unit in a whole-block-based way (e.g., the coding data of the whole CU may be refined).
   2) For example, the refinement process may be applied to a video unit in a subblock/part/partition-based way.
      a) For example, the refinement process may be applied to one or more parts/partitions of a video unit (in case of the coding unit contains more than one parts/partitions) rather than all partitions of the coding unit.
      b) For example, the refinement process may be applied to one or more subblocks of the coding unit rather than the entire coding unit.
         i. For example, the subblocks may be represented by a size of M×N (such as M=N=4 or 8) samples which is less than the size of the whole coding unit.
         ii. For example, the subblocks at pre-defined positions (such as above or left border) may be taken into account.
      c) Alternatively, the refinement process may be applied to all parts/partitions/subblocks of the coding unit.
      d) In one example, whether to and/or how to apply a refinement process on a sub-block may depend on the location of the sub-block.
         i. For example, a first refinement process is applied on a sub-block at boundaries of a block, and a second refinement process is applied on a sub-block not at boundaries of a block.
      e) In one example, the refined results of a first subblock may be used to refine a second subblock of the block.
         i. Alternatively, the refined results of a first subblock cannot be used to refine a second subblock of the block.
4. In one example, whether or not apply the refinement process to a video unit and/or how to apply the refinement process may be controlled by one or multiple syntax elements (e.g., a flag).
   1) For example, whether to signal syntax elements related to a refinement process Y may be dependent on the type of the coding technique X that applied the video unit.
      a) For example, for a particular coding technique X1 coded video unit, whether to use refinement process Y1 may be indicated by a syntax flag.
      b) Alternatively, for another particular coding technique X2 coded video unit, a refinement process Y2 may be mandatorily applied, without explicit signalling.
5. In one example, whether to use refined coding data or original coding data (before being refined) for processing the current video unit and/or proceeding video units, may be dependent on what coding technique X is applied to the video unit.
   1) In one example, a refined motion of a video unit may be used to generate the motion compensated prediction samples.
      a) Alternatively, the original motion without the refinement may be used to generate the motion compensated prediction samples for a video unit.
   2) In one example, a refined motion of a video unit may be used to determine parameters in a loop filter process.
      a) For example, the refined motion may be used for the deblocking strength determination for a video unit.
      b) Alternatively, the original motion without the refinement may be used for the deblocking strength determination for a video unit.
   3) In one example, refined coding data of a first video unit may be stored for coding information derivation for a second video unit.
      a) For example, the refined motion vector may be stored in a M×N (such as M=N=4 or 8 or 16) subblock basis.
         i. Alternatively, the refined motion vector may be stored in a CU basis.
      b) For example, the refinement motion vector for a first video unit may be stored for the spatial motion candidate derivation for a second video unit.
         i. Alternatively, the original motion without the refinement for a first video unit may be stored for the spatial motion candidate derivation for a second video unit.
      c) For example, the refinement motion vector for a first video unit may be stored for the temporal motion candidate derivation for a second video unit.
      d) For example, the refinement intra prediction mode for a first video unit may be stored for the intra MPM list generation for a second video unit.
6. In one example, whether to and/or how to apply a refinement process may depend on color format and/or color component.
   1) In one example, a refinement process is applied on a first color component but not on a second color component.
7. In one example, whether to and/or how to apply a refinement process may depend on dimensions W×H of a block.
   1) For example, a refinement process may not be applied if W>=T1 and/or H>=T2.
   2) For example, a refinement process may not be applied if W<=T1 and/or H<=T2.
   3) For example, a refinement process may not be applied if W>T1 and/or H>T2.
   4) For example, a refinement process may not be applied if W<T1 and/or H<T2.
   5) For example, a refinement process may not be applied if W×H>=T.
   6) For example, a refinement process may not be applied if W×H>T.
   7) For example, a refinement process may not be applied if W×H<=T.
   8) For example, a refinement process may not be applied if W×H<T.

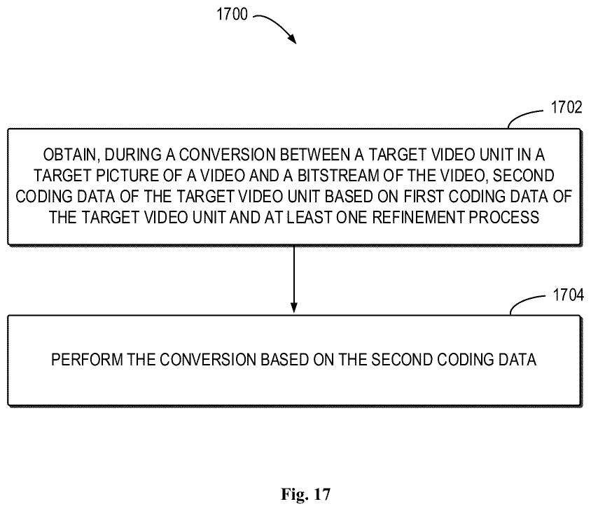

FIG. 17 illustrates a flowchart of a method 1700 for video processing in accordance with some embodiments of the present disclosure. As shown in FIG. 17, the method 1700 comprises: obtaining 1702, during a conversion between a target video unit in a target picture of a video and a bitstream of the video, second coding data of the target video unit based on first coding data of the target video unit and at least one refinement process, the at least one refinement process being applied based on a predefined criterion; and performing 1704 the conversion based on the second coding data.

According to the method 1700, multiple refinement processes may be applied to refine motion information of a video. Moreover, whether to apply the refinement process or how to apply the refinement process may depend on the type of coding technique for coding the motion data and requirements of video processing. Therefore, the prediction derived based on the proposed solution is more precise. Compared with the conventional solution, the method 1700 in accordance with some embodiments of the present disclosure can advantageously improve the coding performance and efficiency.

In some embodiments, the predefined criterion may indicate whether to apply the at least one refinement process or how to apply the at least one refinement process. In these embodiments, the predefined criterion may be indicated by one or more syntax elements included in the bitstream. In this case, whether or not to apply the refinement process on a video unit and/or how to apply the refinement process may be controlled by one or multiple syntax elements (e.g., a flag).

In some embodiments, the first coding data may be coded by a target coding mode and whether a syntax element indicating the predefined criterion is included in the bitstream is based on the target coding mode. That is, whether to signal syntax elements related to a particular refinement process may depend on the type of the coding technique applied on the video unit.

In some embodiments, in response to the target coding mode being a first predetermined coding mode, a syntax element indicating whether to apply a first refinement process of the at least one refinement process is included in the bitstream. For example, for a video unit coded by a particular coding technique X1, whether to use a refinement process Y1 may be indicated by a syntax flag.

In some embodiments, in response to the target coding mode being a second predetermined coding mode, a second refinement process of the at least one refinement process may be mandatorily applied. For example, for a video unit coded by another particular coding technique X2, a refinement process Y2 may be mandatorily applied, without explicit signalling.

In some embodiments, the predefined criterion may indicate whether or how to apply the at least one refinement process is based on at least one of a color format of the target video unit or a color component of the target video unit.

In some embodiments, the target video unit may comprise at least a first color component and a second color component, and the predefined criterion may indicate that the at least one refinement process is applied on the first color component rather than the second color component.

In some embodiments, the predefined criterion may indicate whether to apply the at least one refinement process based on a dimension of the target video unit.

In some embodiments, the predefined criterion may indicate that the at least one refinement process is not applied, in response to a width of the target video unit being larger than or equal to a threshold width, and/or a height of the target video unit being larger than or equal to a threshold height.

For example, the width of the target video may be denoted by W, and the threshold width may be T1. In addition, the height of the target video unit may be denoted by H, and the threshold height may be T2. In an example, a refinement process may not be applied if W≥T1 and/or H≥T2. In another example, a refinement process may not be applied if W>T1 and/or H>T2.

In some embodiments, the predefined criterion may indicate that the at least one refinement process is not applied, in response to a width of the target video unit being less than or equal to a threshold width, and/or a height of the target video unit being less than or equal to a threshold height. In an example, a refinement process may not be applied if W≤T1 and/or H≤T2. In another example, a refinement process may not be applied if a refinement process may not be applied if W<T1 and/or H<T2.

In some embodiments, the predefined criterion may indicate that the at least one refinement process is not applied, in response to a product of a width and a height of the target video unit being greater than or equal to a threshold product. For example, the width of the target video may be denoted by W, and the height of the target video unit may be denoted by H. The threshold product may be denoted by T. By way of example, a refinement process may not be applied if W×H≥T. By way of another example, a refinement process may not be applied if W×H>T.

In some embodiments, the predefined criterion may indicate that the at least one refinement process is not applied, in response to a product of a width and a height of the target video unit being less than or equal to a threshold product. By way of example, a refinement process may not be applied if W×H≤T. By way of another example, a refinement process may not be applied if W×H <T.

In some embodiments, the at least one refinement process may be applied on at least one of parts of the target video unit.

In some embodiments, the predefined criterion may indicate that the at least one refinement process is applied on the target video unit on a whole-block basis.

In some embodiments, the predefined criterion may indicate that the at least one refinement process is applied on the target video unit on a non-whole-block basis, and a non-whole-block of the target video unit may comprise one of a subblock, a part or a partition.

In some embodiments, the first coding data is coded by a target coding mode, and the at least one refinement process is applied on a subset of parts or partitions of the target video unit, and the target coding mode may comprise one of GPM TM, MMVD, GPM inter-intra, or CIIP TM.

In some embodiments, the predefined criterion may indicate that the at least one refinement process is applied on a subset of subblocks of the target video unit.

In some embodiments, each subblock of the subset of subblocks of the target video unit may be represented by samples of a size less than a size of the target video unit. By way of example, the subblocks may be represented by a size of M×N samples which is less than a size of the whole CU, where the values of M and N may be, for example, M=N=4 or 8. It should be understood that the values and configurations are given for the illustrative purpose, and any other suitable values and configurations are also applicable to implementations of the present disclosure. Therefore, the scope of the present disclosure is not limited in this regard.

In some embodiments, the subset of subblocks of the target video unit may be at predefined locations in the target video unit. The predefined locations may be, for example, the above or left border of the video block.

In some embodiments, the predefined criterion may indicate that the at least one refinement process is applied on all the subblocks of the target video unit, or all the partitions of the target video unit.

In some embodiments, the predefined criterion may indicate whether and/or how to apply the at least one refinement process or how to apply the at least one refinement process is based on a location of a subblock of the target video unit.

In some embodiments, the at least one refinement process may comprise a first refinement process and a second refinement process, and the predefined criterion may indicate the following: applying the first refinement process on a subblock located at a boundary of the target video unit, and applying the second refinement process on a subblock not located at the boundary of the target video unit.

In some embodiments, the target coding mode may comprise a temporal motion (TM) based overlapped block-based motion compensation (OBMC) mode.

In some embodiments, the predefined criterion may indicate that a second coding data of a first subblock of the target video unit is used for refining a second subblock of the target video unit.

In some embodiments, the predefined criterion may indicate that a second coding data of a first subblock of the target video unit is not used for refining a second subblock of the target video unit.

In some embodiments, the at least one refinement process may comprise a plurality of refinement process comprising at least a first refinement process and a second refinement process.

In some embodiments, the predefined criterion may indicate that the first refinement process is applied for refining a first kind of first coding data, and the second refinement process is applied for refining a second kind of first coding data. In this case where multiple refinement processes are applied, different kinds of coding data may be refined by different refinement processes. As such, the prediction is more precise.

In some embodiments, the first coding data may comprise motion information and intra prediction modes.

In some embodiments, the first coding data may be coded by a target coding mode comprising a combined inter-intra prediction (CIIP) mode, and the first refinement process may be based on an inter temporal motion (TM) mode, and the second refinement process may be based on a template-based intra mode derivation (TIMD) mode, and the predefined criterion indicates that an inter part of the first coding data is refined based on the TM mode, and an intra part of the first coding data is refined based on the TIMD mode.

In some embodiments, the predefined criterion may indicate that the at least one refinement process is applied on a video unit coded by an inter and intra combined prediction mode.

In some embodiments, the target coding mode may comprise a GPM inter and intra combined prediction mode, and the first refinement process is based on a GPM MMVD mode, and the second refinement process is based on one of a template-based intra mode derivation (TIMD) mode or a decoder-side intra mode derivation (DIMD) mode, and the predefined criterion indicates that an inter part of the first coding data is refined based on the GPM MMVD mode, and an intra part of the first coding data is refined based on the corresponding one of the TIMD mode or the DIMD mode.

In some embodiments, the predefined criterion may indicate that the plurality of refinement process are applied for refining the same kind of the first coding data.

In some embodiments, the first coding data may comprise motion information of the target video unit, the first refining processing is based on a decoder side motion vector refinement (DMVR) mode, and the second refining processing is based on a temporal motion (TM) based mode comprising one of am inter TM mode, a AMVP merge mode, or a GPM mode.

In some embodiments, obtaining 1702 the second coding data may comprise: determining temporary refined motion information based on the first coding data and at least one of the plurality of refinement process; and obtaining, based on the temporary refined motion information, the second coding data as final refined motion information of the target video unit.

In some embodiments, the second coding data may comprise temporary refined motion information. In these embodiments, performing 1704 the conversion may comprise: determining, based on the temporary refined motion information, final refined motion information of the target video unit; and performing the conversion based on the final refined motion information.

In some embodiments, the final refined motion information may comprise merge mode temporal motion vector prediction (TMVP), and the plurality of refinement process may comprise a TM refinement process and a TM sorting processing.

In some embodiments, the conversion at 1704 may comprise decoding the target picture from the bitstream of the video

In some embodiments, the conversion at 1704 may comprise encoding the target picture into the bitstream of the video.

Implementations of the present disclosure can be described in view of the following clauses, the features of which can be combined in any reasonable manner.

Clause 1. A method for video processing, comprising: obtaining, during a conversion between a target video unit in a target picture of a video and a bitstream of the video, second coding data of the target video unit based on first coding data of the target video unit and at least one refinement process, the at least one refinement process being applied based on a predefined criterion; and performing the conversion based on the second coding data.

Clause 2. The method of clause 1, wherein the predefined criterion indicates whether to apply the at least one refinement process or how to apply the at least one refinement process.

Clause 3. The method of clause 2, wherein the predefined criterion is indicated by one or more syntax elements included in the bitstream.

Clause 4. The method of clause 1, wherein the first coding data is coded by a target coding mode and whether a syntax element indicating the predefined criterion is included in the bitstream is based on the target coding mode.

Clause 5. The method of clause 4, wherein in response to the target coding mode is a first predetermined coding mode, a syntax element indicating whether to apply a first refinement process of the at least one refinement process is included in the bitstream.

Clause 6. The method of clause 4, wherein in response to the target coding mode is a second predetermined coding mode, a second refinement process of the at least one refinement process is mandatorily applied.

Clause 7. The method of clause 1, wherein the predefined criterion indicates whether or how to apply the at least one refinement process is based on at least one of a color format of the target video unit or a color component of the target video unit.

Clause 8. The method of clause 7, wherein the target video unit comprises at least a first color component and a second color component, and the predefined criterion indicates that the at least one refinement process is applied on the first color component rather than the second color component.

Clause 9. The method of clause 1, wherein the predefined criterion indicates whether to apply the at least one refinement process based on a dimension of the target video unit.

Clause 10. The method of clause 9, wherein the predefined criterion indicates that the at least one refinement process is not applied, in response to a width of the target video unit being larger than or equal to a threshold width, and/or a height of the target video unit being larger than or equal to a threshold height.

Clause 11. The method of clause 9, wherein the predefined criterion indicates that the at least one refinement process is not applied, in response to a width of the target video unit being less than or equal to a threshold width, and/or a height of the target video unit being less than or equal to a threshold height.

Clause 12. The method of clause 9, wherein the predefined criterion indicates that the at least one refinement process is not applied, in response to a product of a width and a height of the target video unit being greater than or equal to a threshold product.

Clause 13. The method of clause 9, wherein the predefined criterion indicates that the at least one refinement process is not applied, in response to a product of a width and a height of the target video unit being less than or equal to a threshold product.

Clause 14. The method of clause 1, wherein the at least one refinement process is applied on at least one of parts of the target video unit.

Clause 15. The method of clause 1, wherein the predefined criterion indicates that the at least one refinement process is applied on the target video unit on a whole-block basis.

Clause 16. The method of clause 1, wherein the predefined criterion indicates that the at least one refinement process is applied on the target video unit on a non-whole-block basis, and a non-whole-block of the target video unit comprises one of a subblock, a part or a partition.

Clause 17. The method of clause 16, wherein the first coding data is coded by a target coding mode, and the at least one refinement process is applied on a subset of parts or partitions of the target video unit, and the target coding mode comprises one of GPM TM, MMVD, GPM inter-intra, or CIIP TM.

Clause 18. The method of clause 16, wherein the predefined criterion indicates that the at least one refinement process is applied on a subset of subblocks of the target video unit.

Clause 19. The method of clause 18, wherein each subblock of the subset of subblocks of the target video unit is represented by samples of a size less than a size of the target video unit.

Clause 20. The method of clause 18, wherein the subset of subblocks of the target video unit are at predefined locations in the target video unit.

Clause 21. The method of clause 16, wherein the predefined criterion indicates that the at least one refinement process is applied on all the subblocks of the target video unit, or all the partitions of the target video unit.

Clause 22. The method of clause 16, wherein the predefined criterion indicates whether and/or how to apply the at least one refinement process or how to apply the at least one refinement process is based on a location of a subblock of the target video unit.

Clause 23. The method of clause 22, wherein the at least one refinement process comprises a first refinement process and a second refinement process, and the predefined criterion indicates the following: applying the first refinement process on a subblock located at a boundary of the target video unit, and applying the second refinement process on a subblock not located at the boundary of the target video unit.

Clause 24. The method of clause 22 or clause 23, wherein the target coding mode comprises a temporal motion (TM) based overlapped block-based motion compensation (OBMC) mode.

Clause 25. The method of clause 16, wherein the predefined criterion indicates that a second coding data of a first subblock of the target video unit is used for refining a second subblock of the target video unit.

Clause 26. The method of clause 16, wherein the predefined criterion indicates that a second coding data of a first subblock of the target video unit is not used for refining a second subblock of the target video unit.

Clause 27. The method of clause 1, wherein the at least one refinement process comprises a plurality of refinement process comprising at least a first refinement process and a second refinement process.

Clause 28. The method of clause 27, wherein the predefined criterion indicates that the first refinement process is applied for refining a first kind of first coding data, and the second refinement process is applied for refining a second kind of first coding data.

Clause 29. The method of clause 28, wherein the first coding data comprises motion information and intra prediction modes.

Clause 30. The method of clause 29, wherein the first coding data is coded by a target coding mode comprising a combined inter-intra prediction (CIIP) mode, and the first refinement process is based on an inter temporal motion (TM) mode, and the second refinement process is based on a template-based intra mode derivation (TIMD) mode, and wherein the predefined criterion indicates that an inter part of the first coding data is refined based on the TM mode, and an intra part of the first coding data is refined based on the TIMD mode.

Clause 31. The method of clause 29, wherein the predefined criterion indicates that the at least one refinement process is applied on a video unit coded by an inter and intra combined prediction mode.

Clause 32. The method of clause 31, wherein the target coding mode comprises a GPM inter and intra combined prediction mode, and the first refinement process is based on a GPM MMVD mode, and the second refinement process is based on one of a template-based intra mode derivation (TIMD) mode or a decoder-side intra mode derivation (DIMD) mode, and wherein the predefined criterion indicates that an inter part of the first coding data is refined based on the GPM MMVD mode, and an intra part of the first coding data is refined based on the corresponding one of the TIMD mode or the DIMD mode.

Clause 33. The method of clause 27, wherein the predefined criterion indicates that the plurality of refinement process are applied for refining the same kind of the first coding data.

Clause 34. The method of clause 33, wherein the first coding data comprises motion information of the target video unit, the first refining processing is based on a decoder side motion vector refinement (DMVR) mode, and the second refining processing is based on a temporal motion (TM) based mode comprising one of am inter TM mode, a AMVP merge mode, or a GPM mode.

Clause 35. The method of clause 33, wherein obtaining the second coding data comprises: determining temporary refined motion information based on the first coding data and at least one of the plurality of refinement process; and obtaining, based on the temporary refined motion information, the second coding data as final refined motion information of the target video unit.

Clause 36. The method of clause 27, wherein the second coding data comprises temporary refined motion information and wherein performing the conversion comprises: determining, based on the temporary refined motion information, final refined motion information of the target video unit; and performing the conversion based on the final refined motion information.

Clause 37. The method of clause 36, wherein the final refined motion information comprises merge mode temporal motion vector prediction (TMVP), and the plurality of refinement process comprises a TM refinement process and a TM sorting processing.

Clause 38. The method of any of clauses 1 to 37, wherein the conversion comprises decoding the target picture from the bitstream of the video.

Clause 39. The method of any of clauses 1 to 37, wherein the conversion comprises encoding the target picture into the bitstream of the video.

Clause 40. An apparatus for video processing, comprising a processor and a non- transitory memory coupled to the processor and having instructions stored thereon, wherein the instructions upon execution by the processor, cause the processor to: obtain, during a conversion between a target video unit in a target picture of a video and a bitstream of the video, second coding data of the target video unit based on first coding data of the target video unit and at least one refinement process, the at least one refinement process being applied based on a predefined criterion; and generate the bitstream based on the second coding data.

Clause 41. A non-transitory computer-readable storage medium storing instructions that cause a processor to perform a method in accordance with any of clauses 1 to 39.

Clause 42. A non-transitory computer-readable recording medium storing a bitstream of a video which is generated by a method performed by an apparatus for video processing, wherein the method comprises: obtaining, during a conversion between a target video unit in a target picture of a video and a bitstream of the video, second coding data of the target video unit based on first coding data of the target video unit and at least one refinement process, the at least one refinement process being applied based on a predefined criterion; and generating the bitstream based on the second coding data.

Clause 43. A method for storing a bitstream of a video, comprising: obtaining, during a conversion between a target video unit in a target picture of a video and a bitstream of the video, second coding data of the target video unit based on first coding data of the target video unit and at least one refinement process, the at least one refinement process being applied based on a predefined criterion; generating the bitstream based on the second coding data; and storing the bitstream in a non-transitory computer-readable recording medium.

### Example Device

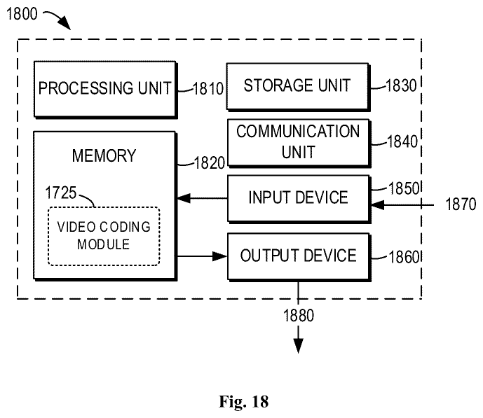

FIG. 18 illustrates a block diagram of a computing device 1800 in which various embodiments of the present disclosure can be implemented. The computing device 1800 may be implemented as or included in the source device 110 (or the video encoder 114 or 200) or the destination device 120 (or the video decoder 124 or 300).

It would be appreciated that the computing device 1800 shown in FIG. 18 is merely for purpose of illustration, without suggesting any limitation to the functions and scopes of the embodiments of the present disclosure in any manner.

As shown in FIG. 18, the computing device 1800 includes a general-purpose computing device 1800. The computing device 1800 may at least comprise one or more processors or processing units 1810, a memory 1820, a storage unit 1830, one or more communication units 1840, one or more input devices 1850, and one or more output devices 1860.

In some embodiments, the computing device 1800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1800 can support any type of interface to a user (such as “wearable” circuitry and the like).

The processing unit 1810 may be a physical or virtual processor and can implement various processes based on programs stored in the memory 1820. In a multi-processor system, multiple processing units execute computer executable instructions in parallel so as to improve the parallel processing capability of the computing device 1800. The processing unit 1810 may also be referred to as a central processing unit (CPU), a microprocessor, a controller or a microcontroller.

The computing device 1800 typically includes various computer storage medium. Such medium can be any medium accessible by the computing device 1800, including, but not limited to, volatile and non-volatile medium, or detachable and non-detachable medium. The memory 1820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1830 may be any detachable or non-detachable medium and may include a machine-readable medium such as a memory, flash memory drive, magnetic disk or another other media, which can be used for storing information and/or data and can be accessed in the computing device 1800.

The computing device 1800 may further include additional detachable/non- detachable, volatile/non-volatile memory medium. Although not shown in FIG. 18, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1840 communicates with a further computing device via the communication medium. In addition, the functions of the components in the computing device 1800 can be implemented by a single computing cluster or multiple computing machines that can communicate via communication connections. Therefore, the computing device 1800 can operate in a networked environment using a logical connection with one or more other servers, networked personal computers (PCs) or further general network nodes.

The input device 1850 may be one or more of a variety of input devices, such as a mouse, keyboard, tracking ball, voice-input device, and the like. The output device 1860 may be one or more of a variety of output devices, such as a display, loudspeaker, printer, and the like. By means of the communication unit 1840, the computing device 1800 can further communicate with one or more external devices (not shown) such as the storage devices and display device, with one or more devices enabling the user to interact with the computing device 1800, or any devices (such as a network card, a modem and the like) enabling the computing device 1800 to communicate with one or more other computing devices, if required. Such communication can be performed via input/output (I/O) interfaces (not shown).

In some embodiments, instead of being integrated in a single device, some or all components of the computing device 1800 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1800 may be used to implement video encoding/decoding in embodiments of the present disclosure. The memory 1820 may include one or more video coding modules 1825 having one or more program instructions. These modules are accessible and executable by the processing unit 1810 to perform the functionalities of the various embodiments described herein.

In the example embodiments of performing video encoding, the input device 1850 may receive video data as an input 1870 to be encoded. The video data may be processed, for example, by the video coding module 1825, to generate an encoded bitstream. The encoded bitstream may be provided via the output device 1860 as an output 1880.

In the example embodiments of performing video decoding, the input device 1850 may receive an encoded bitstream as the input 1870. The encoded bitstream may be processed, for example, by the video coding module 1825, to generate decoded video data. The decoded video data may be provided via the output device 1860 as the output 1880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1-43. (canceled)

44. A method for video processing, comprising:
obtaining, during a conversion between a target video unit in a target picture of a video and a bitstream of the video, second coding data of the target video unit based on first coding data of the target video unit and at least one refinement process, the at least one refinement process being applied based on a predefined criterion; and
performing the conversion based on the second coding data.

45. The method of claim 44, wherein the predefined criterion indicates whether to apply the at least one refinement process or how to apply the at least one refinement process, and wherein the predefined criterion is indicated by one or more syntax elements included in the bitstream.

46. The method of claim 44, wherein the first coding data is coded by a target coding mode and whether a syntax element indicating the predefined criterion is included in the bitstream is based on the target coding mode, and
wherein in response to the target coding mode is a first predetermined coding mode, a syntax element indicating whether to apply a first refinement process of the at least one refinement process is included in the bitstream, or
in response to the target coding mode is a second predetermined coding mode, a second refinement process of the at least one refinement process is mandatorily applied.

47. The method of claim 44, wherein the predefined criterion indicates whether or how to apply the at least one refinement process is based on at least one of a color format of the target video unit or a color component of the target video unit, and the target video unit comprises at least a first color component and a second color component, and the predefined criterion indicates that the at least one refinement process is applied on the first color component rather than the second color component.

48. The method of claim 44, wherein the predefined criterion indicates whether to apply the at least one refinement process based on a dimension of the target video unit, and
wherein the predefined criterion indicates that the at least one refinement process is not applied in response to a width of the target video unit being larger than or equal to a threshold width, and/or a height of the target video unit being larger than or equal to a threshold height, or
wherein the predefined criterion indicates that the at least one refinement process is not applied in response to a width of the target video unit being less than or equal to a threshold width, and/or a height of the target video unit being less than or equal to a threshold height.

49. The method of claim 44, wherein the predefined criterion indicates whether to apply the at least one refinement process based on a dimension of the target video unit, and
wherein the predefined criterion indicates that the at least one refinement process is not applied in response to a product of a width and a height of the target video unit being greater than or equal to a threshold product, or
wherein the predefined criterion indicates that the at least one refinement process is not applied in response to a product of a width and a height of the target video unit being less than or equal to a threshold product.

50. The method of claim 44, wherein the at least one refinement process is applied on at least one of parts of the target video unit, and
wherein the predefined criterion indicates that the at least one refinement process is applied on the target video unit on a whole-block basis, or
wherein the predefined criterion indicates that the at least one refinement process is applied on the target video unit on a non-whole-block basis, and a non-whole-block of the target video unit comprises one of a subblock, a part or a partition.

51. The method of claim 50, wherein the first coding data is coded by a target coding mode, and the at least one refinement process is applied on a subset of parts or partitions of the target video unit, and the target coding mode comprises one of GPM TM, MMVD, GPM inter-intra, or CIIP TM.

52. The method of claim 50, wherein the predefined criterion indicates that the at least one refinement process is applied on a subset of subblocks of the target video unit, and
wherein each subblock of the subset of subblocks of the target video unit is represented by samples of a size less than a size of the target video unit, and/or the subset of subblocks of the target video unit are at predefined locations in the target video unit.

53. The method of claim 50, wherein the predefined criterion indicates that the at least one refinement process is applied on all the subblocks of the target video unit or all the partitions of the target video unit.

54. The method of claim 50, wherein the predefined criterion indicates whether and/or how to apply the at least one refinement process or how to apply the at least one refinement process is based on a location of a subblock of the target video unit,
wherein the at least one refinement process comprises a first refinement process and a second refinement process, and the predefined criterion indicates the following:
applying the first refinement process on a subblock located at a boundary of the target video unit, and
applying the second refinement process on a subblock not located at the boundary of the target video unit,
wherein the target coding mode comprises a temporal motion (TM) based overlapped block-based motion compensation (OBMC) mode.

55. The method of claim 50, wherein the predefined criterion indicates that a second coding data of a first subblock of the target video unit is used for refining a second subblock of the target video unit, or
wherein the predefined criterion indicates that a second coding data of a first subblock of the target video unit is not used for refining a second subblock of the target video unit.

56. The method of claim 44, wherein the at least one refinement process comprises a plurality of refinement process comprising at least a first refinement process and a second refinement process, and
wherein the predefined criterion indicates that the first refinement process is applied for refining a first kind of first coding data, and the second refinement process is applied for refining a second kind of first coding data.

57. The method of claim 56, wherein the first coding data comprises motion information and intra prediction modes, and
wherein the first coding data is coded by a target coding mode comprising a combined inter-intra prediction (CIIP) mode, and the first refinement process is based on an inter temporal motion (TM) mode, and the second refinement process is based on a template-based intra mode derivation (TIMD) mode, and wherein the predefined criterion indicates that an inter part of the first coding data is refined based on the TM mode, and an intra part of the first coding data is refined based on the TIMD mode, or
wherein the predefined criterion indicates that the at least one refinement process is applied on a video unit coded by an inter and intra combined prediction mode, and wherein the target coding mode comprises a GPM inter and intra combined prediction mode, and the first refinement process is based on a GPM MMVD mode, and the second refinement process is based on one of a template-based intra mode derivation (TIMD) mode or a decoder-side intra mode derivation (DIMD) mode, and wherein the predefined criterion indicates that an inter part of the first coding data is refined based on the GPM MMVD mode, and an intra part of the first coding data is refined based on the corresponding one of the TIMD mode or the DIMD mode.

58. The method of claim 56, wherein the predefined criterion indicates that the plurality of refinement process are applied for refining the same kind of the first coding data, and wherein the first coding data comprises motion information of the target video unit, the first refining processing is based on a decoder side motion vector refinement (DMVR) mode, and the second refining processing is based on a temporal motion (TM) based mode comprising one of am inter TM mode, a AMVP merge mode, or a GPM mode.

59. The method of claim 58, wherein the predefined criterion indicates that the plurality of refinement process are applied for refining the same kind of the first coding data, and
wherein obtaining the second coding data comprises:
determining temporary refined motion information based on the first coding data and at least one of the plurality of refinement process; and
obtaining, based on the temporary refined motion information, the second coding data as final refined motion information of the target video unit.

60. The method of claim 56, wherein the second coding data comprises temporary refined motion information and wherein performing the conversion comprises:
determining, based on the temporary refined motion information, final refined motion information of the target video unit; and
performing the conversion based on the final refined motion information,
wherein the final refined motion information comprises merge mode temporal motion vector prediction (TMVP), and the plurality of refinement process comprises a TM refinement process and a TM sorting processing.

61. The method of claim 44, wherein the conversion comprises decoding the target picture from the bitstream of the video, or encoding the target picture into the bitstream of the video.

62. An apparatus for video processing, comprising:
a processor; and a non-transitory memory coupled to the processor and having instructions stored thereon, wherein the instructions upon execution by the processor, cause the processor to:
obtain, during a conversion between a target video unit in a target picture of a video and a bitstream of the video, second coding data of the target video unit based on first coding data of the target video unit and at least one refinement process, the at least one refinement process being applied based on a predefined criterion; and
generate the bitstream based on the second coding data.

63. A non-transitory computer-readable storage medium storing instructions that cause a processor to perform a method comprising:
obtaining, during a conversion between a target video unit in a target picture of a video and a bitstream of the video, second coding data of the target video unit based on first coding data of the target video unit and at least one refinement process, the at least one refinement process being applied based on a predefined criterion; and
performing the conversion based on the second coding data.
